(19) United States
(12) Patent Application Publication
(10) Pub. No.: US 2017/0118537 A1
(43) Pub. Date: Apr. 27, 2017

(54) ADAPTIVE WATERMARKING FOR STREAMING DATA

(71) Applicant: Nagravision S.A., Cheseaux-sur-Lausanne (CH)

(72) Inventors: Philippe Stransky-Heilkron, Cheseaux (CH); Laurent Piron, Aigle (CH)

(21) Appl. No.: 14/977,274

(22) Filed: Dec. 21, 2015

Related U.S. Application Data
(60) Provisional application No. 62/244,683, filed on Oct. 21, 2015.

(51) Int. Cl. H04N 21/8358; H04N 21/2343; H04N 21/254; H04N 21/4627; H04N 21/442; G06T 1/00; H04N 21/258; H04N 21/845; H04N 21/433; H04N 21/2362; H04N 1/32; G06F 21/16; H04N 21/437

(52) U.S. Cl. CPC H04N 21/8358; G06F 21/16; H04N 21/23439; H04N 21/2541; H04N 21/4627; H04N 21/44209; H04N 21/437; H04N 21/25816; H04N 21/8456; H04N 21/433; H04N 21/2362; H04N 1/32229; G06T 1/0028

(57) ABSTRACT

An adaptive watermarking service receives a request including a device identifier and a requested address associated with a first segment of content. The requested address may be identified in a published manifest describing multiple segments for a content item, where each segment is encoded at multiple different bitrates. The adaptive watermarking service identifies multiple storage locations of the first segment in view of the requested address. The multiple storage locations each have a version of the first segment with a watermark value. The adaptive watermarking service selects a return version from the versions associated with the first segment in view of a watermarking rule, where the return version has a watermark value satisfying the watermarking rule. The adaptive watermarking service sends a message with the device identifier and a return storage location that identifies the selected return version.

### TECHNICAL FIELD

The present disclosure relates generally to watermarking data, and is more specifically related to adaptive watermarking for streaming data.

### BACKGROUND

Watermarking traditionally prevents or deters unauthorized copying or use of content. Watermarking content generally refers to marking the content with information that can be used to identify a source or distributor of subsequent copies of the content. Characteristics of a watermark are generally described in terms of robustness against tampering, perceptibility of the embedding technique, and capacity of stored information. Conventionally, a content provider or distributor creates unique watermarked copies of content for each receiving device so that unauthorized copies can be traced to the receiving device. However, creating, storing, and delivering unique copies of content for thousands or millions of devices can exponentially increase networking and storage resource demands. Conventional watermarking is susceptible to detection and analysis by attackers that seek to tamper with the watermark in order to obscure the source of unauthorized copies of the content. For example, a collusion attack is a known tampering technique that collects and combines information from several watermarked copies to circumvent the watermarking.

Adaptive bitrate streaming is a common technique used to stream content over computer networks by dividing the content into segments and encoding segments at various playback quality levels. Generally, a segment encoded at low playback quality levels (e.g., bitrate) can be stored with less memory and can be transmitted over the computer network with greater ease than segments encoded at higher playback quality levels. Adaptive bitrate streaming conventionally allows the receiving device to assemble the segments for continuous playback with decreased buffering time.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 is a block diagram depicting an example network architecture including an individualization server and a watermarking proxy;

FIG. 2 is a flow diagram of an example implementation of a method for a user device requesting content in accordance with one or more implementations of the present disclosure;

FIGS. 3A-3B are block diagrams of example request data and example response data in accordance with one or more implementations of the present disclosure;

FIG. 4 illustrates a block diagram of an example adaptive watermarking service in accordance with one or more implementations of the present disclosure;

FIG. 5 is a flow diagram of one or more implementations of a method for adaptive watermark of digital content;

FIG. 6 illustrates a block diagram of an example adaptive watermarking process in accordance with one or more implementations of the present disclosure;

FIG. 7 is a flow diagram of one implementation of a method for adaptive watermarking of versions of digital content;

FIG. 8 is a flow diagram of one implementation of a method for adaptive watermarking of copies of digital content;

FIG. 9 illustrates a block diagram of one implementation of a computing device.

### DETAILED DESCRIPTION

The present disclosure is directed to selecting versions of a segment of content in order to adaptively watermark a data stream. Digital content (e.g., a movie, a television show, etc.) is typically divided into segments (e.g., a series of frames) for streaming over networks, such as a content delivery network (e.g., broadcast, cable, satellite, internet protocol television (IPTV), etc.). In a content delivery network (CDN), content providers supply digital content to content delivery network operators for delivery to consumers (e.g., devices). The content delivery network operator employs content management systems (i.e., hardware and/or software) to control delivery and provide manage digital rights management (DRM) of content.

For adaptive bitrate streaming, a content delivery network divides each piece of content into segments and encodes the segments at multiple quality levels (e.g., bitrates). The content delivery network can create multiple versions of each segment of a piece of content and encode each version at one of the multiple bitrates. Content delivery networks conventionally store available segments of content in content storage devices (e.g., data store, cache, etc.) on the content delivery network and publish a menu (e.g., manifest) describing the available content and available quality levels to devices (e.g., televisions, set-top boxes, computers, smart phones, tablets, etc.) of consumers. In some cases, content delivery networks can stream content to millions of devices. Devices initiate a stream of segments for a particular piece of content by sending a request based on the manifest. The requesting device traditionally requests a version of a segment with the best available quality level in view of the device's available processing resources (e.g., networking bandwidth, device processing limits, etc.). With increasing demand for streaming content, content delivery networks may leverage network resources to create more robust watermarks by adaptively watermarking a data stream as described herein.

In an example aspect of the present disclosure, a content delivery network transmits a stream of segments to a device and the stream of segments is watermarked with a sequence of watermark values. A watermark value can be a hidden mark embedded in the segment that is invisible or undetectable to receiving devices. For example, the watermark value can be binary (e.g., 0 or 1). In an implementation, a pre-watermarking service embeds a hidden mark as a watermark value in each segment before storing the embedded segment in the content storage devices.

An adaptive watermarking service for a content delivery network selects stored segments or versions of segments that include watermark values in order to adaptively watermark a data stream. The adaptive watermarking service is compatible and interchangeable with different pre-watermarking techniques. A device can request a series of versions of segments to stream content delivered by the content delivery network. The adaptive watermarking service selects the version of a segment that includes a watermark value (e.g., 0 or 1) to produce a stream of segments including an identifiable watermark sequence (e.g., 10110). Digital rights management systems can detect subsequent copies of the stream of segments that include the sequence of watermark values and trace the watermark sequence to the requesting device as the source of the copy.

Implementations of the present disclosure describe an adaptive watermarking service that can thwart attacks and leverage adaptive bitrate streaming techniques to select versions of a segment of content in order to adaptively watermark a data stream. In an example aspect, the pre-watermarking service can embed alternating watermark values (e.g., binary values) in multiple versions of a segment where each version is encoded at a different bitrate. The adaptive watermarking service can respond to device request with a version of the segment that satisfies a watermarking rule. In an implementation, the adaptive watermarking service selects a version that is less than or equal to the requested quality level where the version includes a watermark value that satisfies the watermarking rule. For example, to create an identifiable sequence in view of a prior request from the device, the adaptive watermarking service can select versions of the segment encoded at a lower quality level than the requested version in view of the watermarking rule. The stream of segments may include segment versions with a watermark value at a lower quality level than the receiving device is capable of processing to produce the identifiable sequence. The adaptive watermarking service leverages existing stored content and uses minimal processing resources to include an adaptable watermark in data streams to multiple devices.

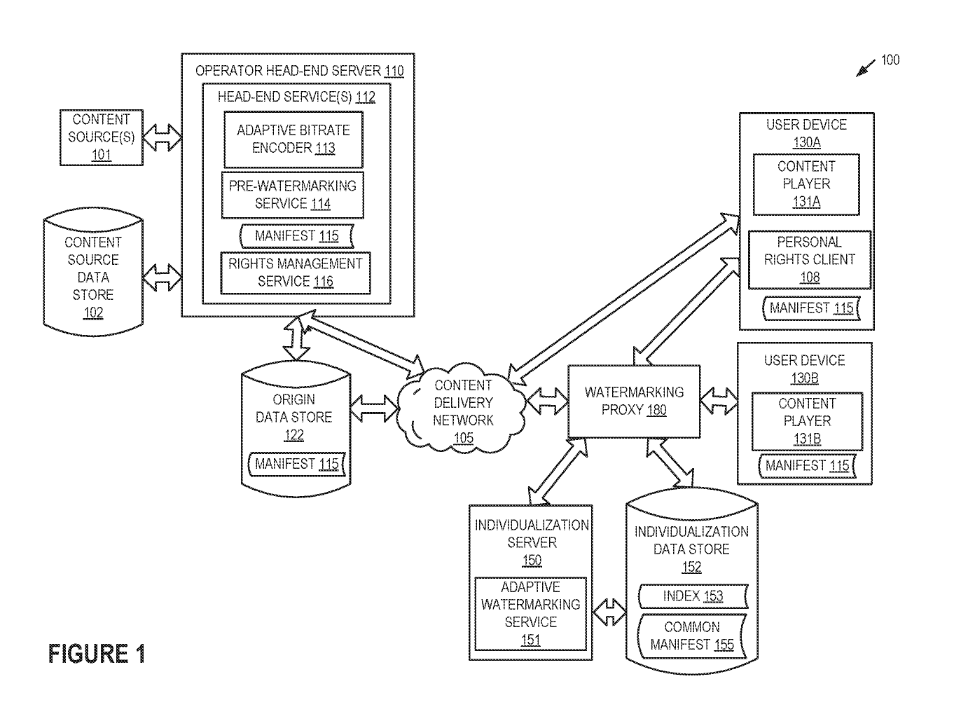

FIG. 1 is a block diagram depicting an example network architecture 100 including an individualization server 150 and a watermarking proxy 180. The system 100 can include an operator head-end server 110 that stores source content (e.g., a contented source data store 102) or receives source content from one or more content source providers, collectively referred to as content source(s) 101 (e.g., movie studios, production companies, content resellers, etc.). For example, a content source provider can provide digital content of a live sporting event video. The operator head-end server 110 may include physical machines and/or virtual machines hosted by physical machines. The physical machines may be rackmount servers, desktop computers, or other computing devices.

The operator head-end server 110 processes the source content for distribution over a content delivery network 105. The operator head-end server 110 includes head-end services 112 such as an adaptive bitrate encoder 113 and a pre-watermarking service 114. The adaptive bitrate encoder 113 can divide a piece of source content into several segments and encode each segment at a quality level (e.g., bitrate). For example, a television show that is 30 minutes long can be divided into 360 segments that are about 5 seconds in duration. The adaptive bitrate encoder 113 can encode (e.g., translate) the segments to a bitrate that uses less memory to store and/or bandwidth to transmit over a network. Bitrate can refer to the size of a file, for example, in bytes divided by the playback time of the content, multiplied by eight. The adaptive bitrate encoder 113 can create multiple versions of a segment and encode the versions at different bitrates to allow for adaptive streaming of the segments. Devices can string together versions of different segments at available bitrates to improve continuous playback during periods of fluctuating performance (e.g., network speeds, bandwidth availability, etc.).

A pre-watermarking service 114 can add a hidden mark or watermark value to each versions of a segment. The watermark value can be used for identifying the source of a subsequent copy of the segment. For example, the pre-watermarking service 114 can add a watermark value of “1” to a first version of a segment and add a hidden mark of “0” to a second version of a segment. In an implementation, the pre-watermarking service 114 can mark each version of a segment with a watermark value based on the encoded bitrate of the versions. For example, the pre-watermarking service 114 can mark a first version of a segment encoded at a low bitrate with a watermark value of “0” and a second version of the segment encoded at a high bitrate with a watermark value of “1”.

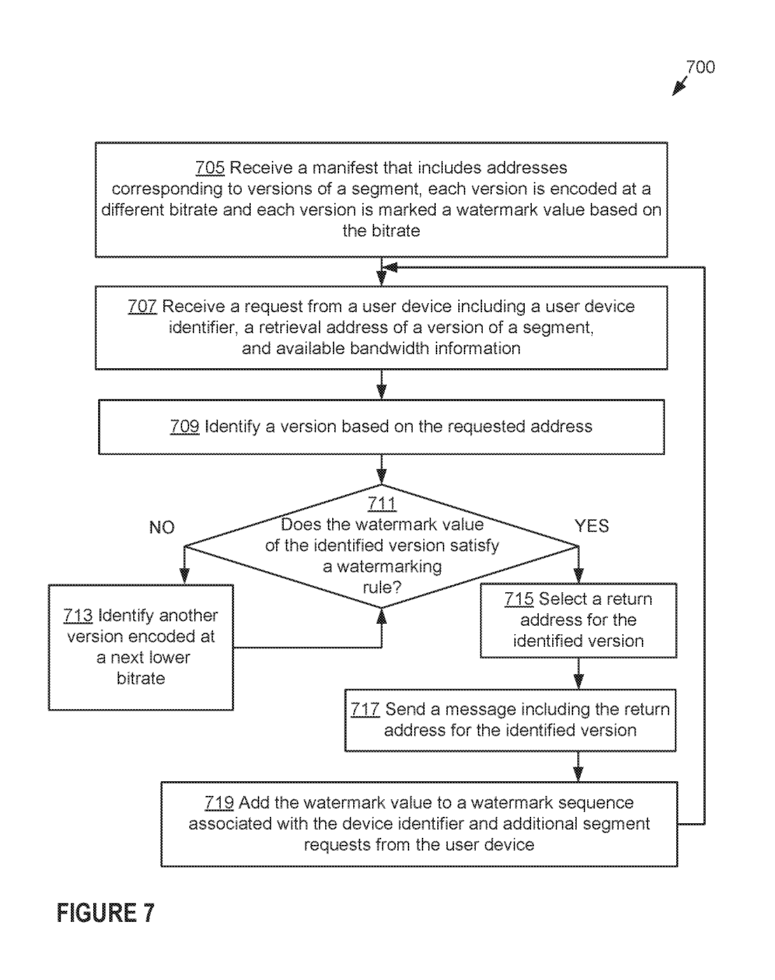

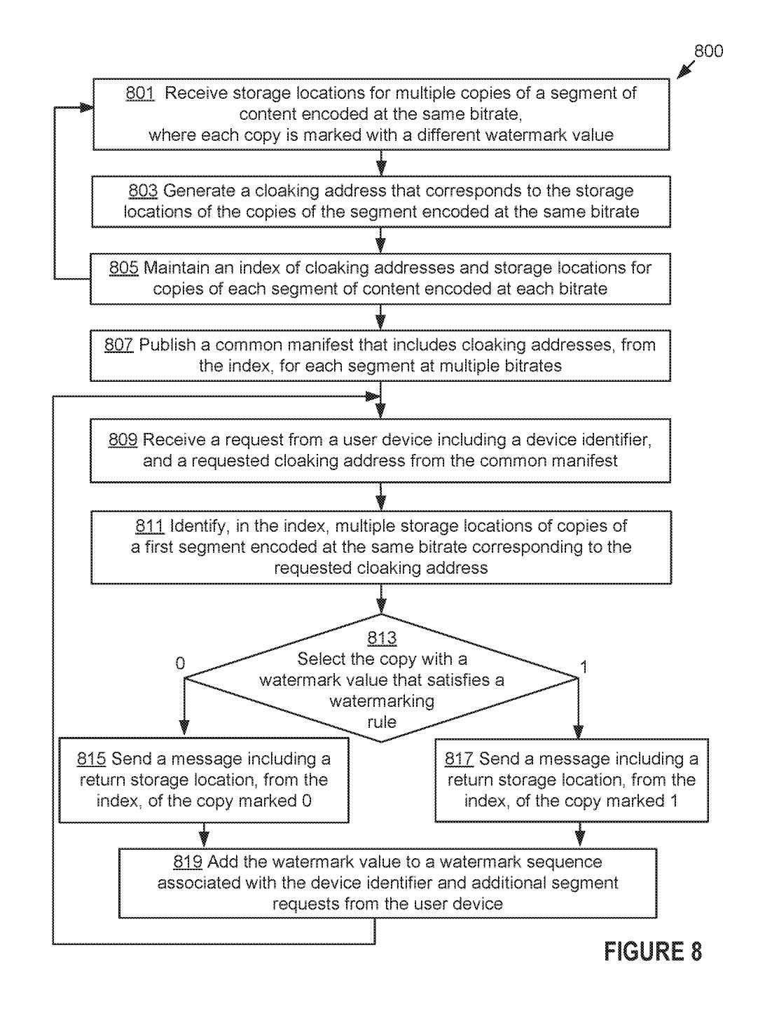

Delivering content using adaptive streaming, the same content may exist in a number of different segments, each segment being encoded at a different quality level such that the most appropriate quality of a segment is chosen, dependent on the processing parameters of the user device or the network (e.g., available bandwidth, processing level of the user device, etc.). The head-end services 112 can store the versions of segments in an origin data store 122 as chunks of data in the origin data store 122. A chunk may refer to a stored version of a segment accessible by a storage location. In an implementation, the head-end services 112 generate a manifest 115 that includes the addresses for the storage location of each version of each segment, segment information to enable playback of the version of the segment, and other information to describe the content of each version of the segment. For example, the retrieval address for a version of a segment can be a Uniform Resource Locator (URL) that points to the storage location of a chunk in the origin data store 122. In an implementation, there may be a retrieval address for each chunk of a segment that is a URL pointing to an index 153 or storage location of each chunk in the origin data store 122, as discussed with reference to FIG. 7. In some implementations, the origin data store 122 stores duplicate copies of segments encoded at the same bitrate (e.g., a version is a copy of a segment) as multiple chunks associated with a retrieval address. In an alternative implementation, the retrieval address for duplicate copies of a segment may be a URL pointing to an index 153 containing a storage location for each copy in the origin data store 122, as discussed with reference to FIG. 8.

The content delivery network 105 can distribute content stored in the origin data store 122 to multiple user devices (e.g., user devices 130A-B) for playback of the content via a content player 131A-B. The content delivery network 105 can include a distributed system of proxy servers (e.g., watermarking proxy 180) and data centers across the Internet. For example, the content delivery network 105 provides high availability and high performance video delivery including live streaming and on-demand streaming. In an implementation, a HTTP streaming server (HSS) can access content that is generally available in packets, and a number of packets may form a segment of content. For example, content is organized as an MPEG2 program stream (MPG-PS). For example, HTTP Live Streaming (HLS) is an HTTP-based media streaming communications protocol that breaks the overall stream into a sequence of small HTTP-based file downloads. Each download loading one short chunk of an overall potentially unbounded transport stream (e.g., streaming content).

The operator head-end server 110 may be hardware configured to perform a particular type of encryption (e.g., rights management service 116) on the content before streaming contents towards an individual user device 130A via the content delivery network 105. Any encryption can be used as the particular type of encryption as long as it is compatible with a system providing a hardware-based root of trust. In an implementation, rights management service 116 is a head-end service 112 for providing a method for adding content protection in a system. For example, using Nagra On-Chip Security (NOCS), each user device 130A-B is provided with a unique token (e.g., personal rights client 108) and secure logic for allowing access to conditional access data.

User devices 130A-B connect to the content delivery network 105 to receive the streaming content. The user devices 130A-B include a content player 131A-B to process received content and present the content, for example, via a display device. The user devices 130A-B can include devices such as electronic book readers, portable digital assistants, mobile phones, smart phones, laptop computers, portable media players, tablet computers, cameras, video cameras, netbooks, notebooks, and the like. The user devices 130A-B can also include devices such as set-top boxes, desktop computers, gaming consoles, digital video recorders (DVRs), media centers, and the like. The user devices 130A-B can connect to the content delivery network 105 by a private network, a WAN, a LAN, etc. The user device 130A-B accesses or downloads a manifest 115 containing a menu for a playlist of available streams. The user device 130A-B plays the stream and sequentially requests a download of a chunk for a next segment from a number of different alternate streams containing the same material encoded at a variety of quality levels (e.g., bitrates). Alternating versions allows the streaming session to adapt to the available processing resources (e.g., bandwidth speed).

User devices 130A-B are each associated with and identifiable by a unique user device identifier (e.g., a token, a digital rights profile, a device serial number, etc.). In an implementation, the user device 130A-B may be a network level device with a personal rights client 108 used to authenticate a user to the rights management service 116. The rights management service 116 can control access to identify a unique identifier for each end user (e.g., a token, a digital rights profile, a device serial number, etc.). For example, Video on demand (VOD) service can stream content through a set-top box, a computer or other device, allowing viewing in real time, or download content to a device such as a computer, digital video recorder or other portable media player for viewing at a later time. The rights management service 116 may receive a unique user identifier to authenticate the device and allow VOD streaming, pay-per-view streaming, downloading to a DVR, etc. The user devices 130A-B send a request for content (herein a “content request”) that includes the unique user identifier, a retrieval address from the manifest 115, and available bandwidth information.

The system 100 includes an individualization server 150 coupled to a watermarking proxy 180 and the content delivery network 105. The watermarking proxy 180 is located in a communication link between the user devices 130A-B and the origin data store 122. The watermarking proxy 180 receives (e.g., intercepts) content requests transmitted between the user devices 130A-B and the content delivery network 105. Watermarking proxy 180 passes the content requests to the individualization server 150. The watermarking proxy 180 is a bi-directional server, in that it can receive both the content requests from the user devices 130A-B and the messages responses from individualization server 150.

The watermarking proxy 180 processes any message and is transparent to the user device 130A-B and content delivery network 105 standpoint. Requests and messages are filtered by watermarking proxy 180 so the individualization server 150 can select the version to return in response to a request. The watermarking proxy 180 processes a return storage location for the return version selected by the individualization server 150 to retrieve the chunk associated with the storage location in the origin data store 122 for delivery to the requesting user device (e.g., 130A or 130B). The watermarking proxy 180 processes each request and message with minimal processing resources allowing millions of user devices 130A-B to receive data streams with a watermarked sequence provided by the individualization server 150.

The individualization server 150 processes the content requests employing an adaptive watermarking service 151 to select a version of a segment of content (e.g., a chunk) to retrieve from the origin data store 122 to produce a data stream that includes an identifiable watermark sequence (e.g., a watermark sequence that may be used to trace or link the data stream to the particular user device receiving the data stream). In an implementation, the individualization server 150 maintains an index 153 in an individualization data store 152. The index 153 can store detection data that associates the unique user identifier of the user device sending the content request(s) with the identifying watermark sequence of streamed data.

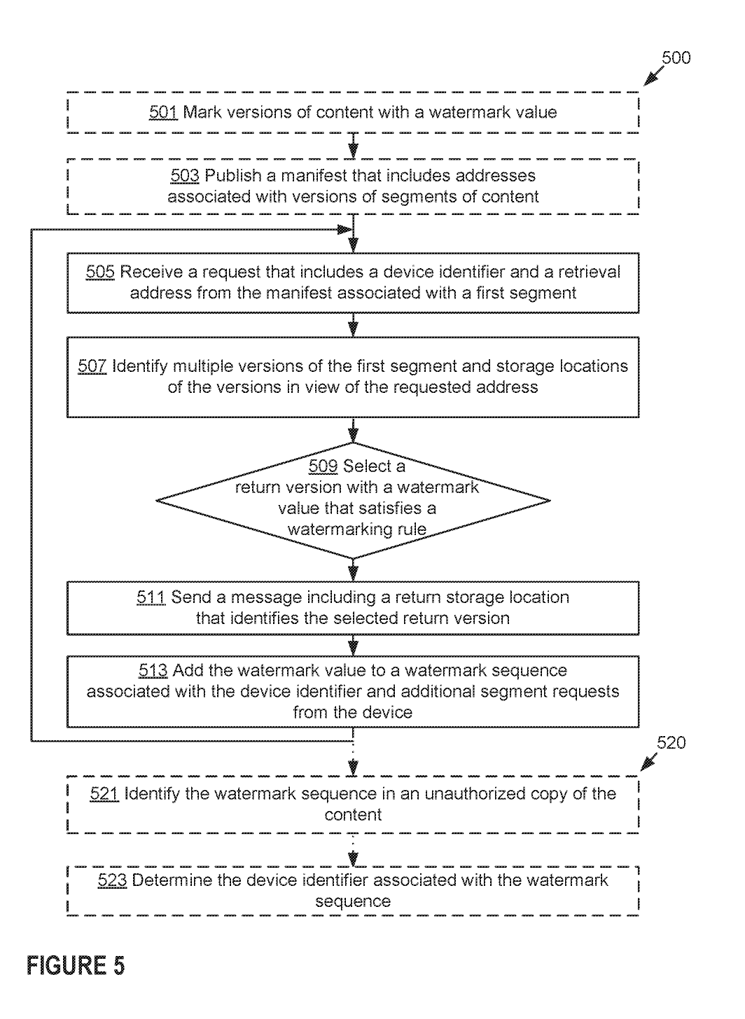

In some implementations, the origin data store 122 stores duplicate copies of segments encoded at the same bitrate (e.g., a version is a copy of a segment) as multiple chunks associated with a retrieval addresses, as discussed in reference to FIG. 8. In an implementation, the index 153 maintains storage locations for chunks and associates a cloaking address with multiple copies of a segment encoded at the same bitrate. The cloaking address points to multiple storage locations comprising copies of a segment encoded at the same bitrate and cloaks the individual storage locations from requesting devices. In an implementation, the individualization server 150 can generate a common manifest 155 with cloaking addresses as retrieval addresses and publish the common manifest 155 via the watermarking proxy 180 to the user devices 130A-B. The common manifest 155 generated by the individualization server 150 can replace manifests 115 published by the operator head-end server 110 that are stored by the user devices 130A-B. The individualization server 150 maintains the index to associate a cloaking address with multiple chunk addresses (e.g., storage locations) for copies of a segment encoded at the same bitrate, as discussed in reference to FIGS. 5 and 8.

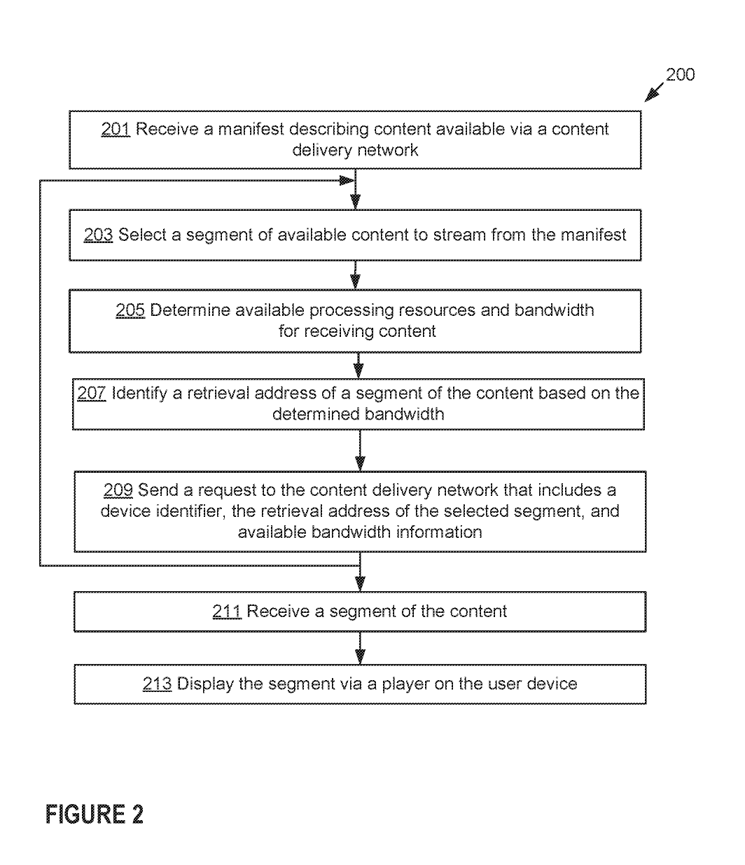

FIG. 2 is a flow diagram of an example implementation of a method 200 for a user device requesting content in accordance with one or more implementations of the present disclosure. Method 200 can be performed by processing logic that can comprise hardware (e.g., circuitry, dedicated logic, programmable logic, microcode, etc.), software (e.g., instructions run on a processing device), or a combination thereof. In an implementation, method 200 is performed by a content player (e.g., content player 131A-B of FIG. 1) executed by a user processing device in a user device (e.g., user device 130A-B of FIG. 1). At least a portion of method 200 can be performed automatically by the user device without user interaction.

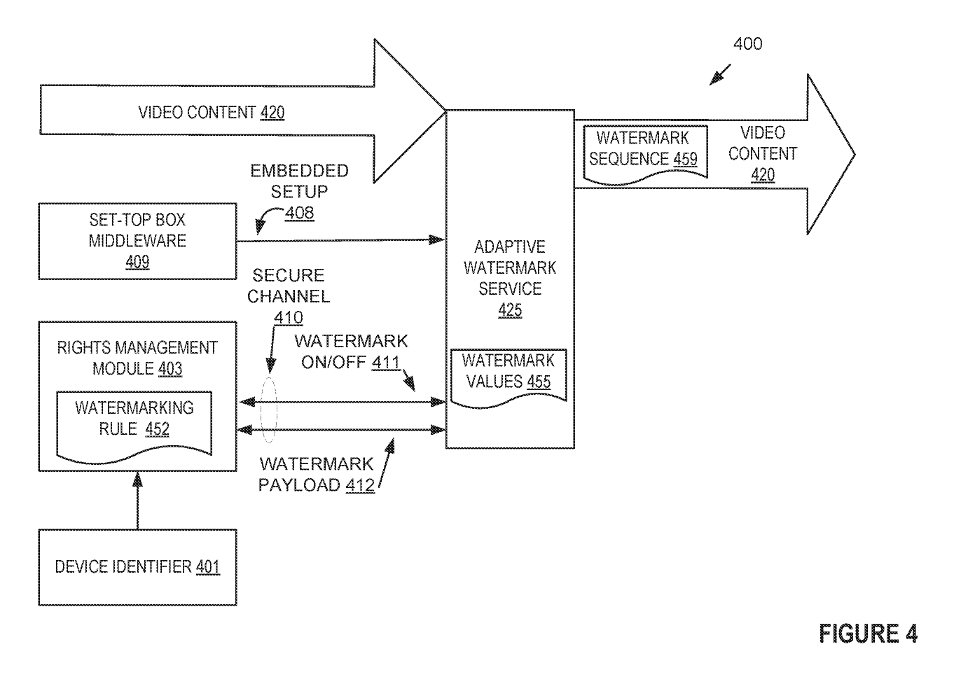

The user processing device may initiate a content request (e.g., a request for a stream of content (e.g., movie, live television, etc.)) from a content delivery network (e.g., CDN 105 of FIG. 1) and receive a stream of segments of content wherein each segment is associated with a watermark value and the multiple watermark values form an identifiable watermark sequence, without changing existing software executed by the user processing device. Implementations of an adaptive watermarking process, as described below in reference to FIGS. 4-9, receive requests from user processing devices independent of modifications to user processing devices and include the watermark sequence in streams of content that are invisible or undetectable to the user devices.

At block 201 of FIG. 2, the user processing device receives a manifest describing content available via the content delivery network. The manifest can include a menu of available content from a content delivery network. The manifest includes retrieval addresses (e.g., URLs) associated with each segment that comprises a content stream. The retrieval address is used by the user device to select a segment and the content delivery network can respond to the retrieval address of a request according to various implementations. For content delivered via adaptive streaming, the manifest can include a retrieval address for versions of each segment encoded at a different available bitrates (e.g., quality levels). For example, a television show that is 30 minutes long can be available in 360 segments that are 5 seconds in duration, each segment available at a low quality bitrate, medium quality bitrate, and high quality bitrate. The manifest can include 3 retrieval addresses corresponding to the versions of the bitrate of each segment and at least 1080 retrieval addresses for the piece of content. In some implementations, the user processing device may receive a unique manifest (e.g., from a content delivery network) or a common manifest (e.g., from an individualization server) that include retrieval addresses. The user processing device may be unaware of the source of the manifest and consistently utilize the received manifest.

At block 203, the user processing device selects a segment of available content to stream from the manifest. At block 205, the user processing device determines available processing resources and bandwidth for receiving content. At block 207, the user processing device identifies a retrieval address of a segment of the content based on the determined bandwidth. At block 209, the user processing device sends a request to the content delivery network that includes a device identifier, the retrieval address of the selected segment, and available bandwidth information.

Blocks 203-209 may be repeated for each segment of the content that is available to the user processing device to allow the user processing device to switch between quality levels for subsequent segments of the same piece of content, thus adapting the data rate (e.g., delivery time) of the content by changing the quality level. For example, if the user processing device has low bandwidth available, the retrieval address corresponding to the low quality bitrate is requested in order to reduce delivery time between adjacent requests and improve continuous playback by the user processing device. The processing device repeats sending a request for a next segment of the content in order to receive a continuous or near continuous stream of replies from the content delivery network. At block 211, the user processing device receives a selected return segment (e.g., a chunk) of the content. At block 213, the user processing device presents (e.g., displays) the segment via a player on the user device.

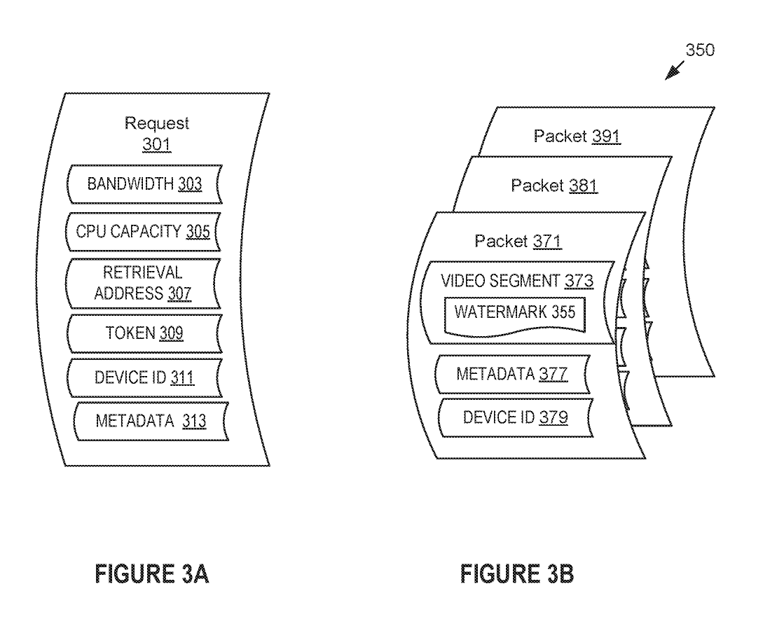

FIG. 3A is a block diagram of example request 301 in accordance with one or more implementations of the present disclosure. The request 301 from a user device (e.g., user devices 130A-B) can include information used to retrieve content from a content storage device (e.g., origin data store 122) via a content delivery network (e.g., content delivery network 105). The request 301 can be based on a protocol. For example, a HTTP protocol can be used that includes information from the user device including available bandwidth 303 of the user device, CPU capacity 305 of the user device, a retrieval address 307 to request a segment of content, a token 309 identifier to authenticate the user device, a device ID 311, and/or metadata 313 (e.g., payment information, location data, advertising data, etc.). The request 301 can also include metadata that communicates usage of digital content on the user device, as well as configurations and setting of applications on the user device. The user device can transmit a series of requests in order to receive a stream of video segments.

FIG. 3B is a block diagram of example response data 350 in accordance with one or more implementations of the present disclosure. The content delivery network can return a group of packets 371, 381, 391 that include one or more video segments 373. The video segment 373 may include an embedded watermark 355 value as described herein. The packets 371, 381, 391 can include additional information, such as device ID 379, routing information and metadata 377. For example, metadata may be usage rules and restrictions for personal rights management enforcement.

FIG. 4 illustrates a block diagram 400 of an example adaptive watermarking service 425 in accordance with one or more implementations of the present disclosure. The diagram 400 illustrates implementations of the adaptive watermarking service 425 as part of a data stream (e.g., video content 420) with multiple versions embedded with different watermark values. To determine the versions of the data stream to deliver to a device, an adaptive watermarking service 425 selects the versions marked with watermark values 455 satisfying a watermarking rule 452, as discussed in greater detail below in reference to FIGS. 5-8.

The watermarking rule 452 is determined based on an authentication process (e.g., a rights management module 403 or embedded setup 408) with the requesting device. The video content 420 that includes a watermark sequence 459 is traceable to the specific requesting device identified by the device identifier 401 during the authentication process. In an implementation, segments of the video content 420 are marked with alternating watermark values 455 and the adaptive watermarking service 425 mixes or blends the versions of the video content 420 (e.g., different encoded bitrates) of adjacent segments in the streamed data to create an identifiable watermark sequence 459 associated with the device identifier 401.

A rights management module 403 (e.g., rights management service 116 or personal rights client 108 of FIG. 1) can authenticate device requests to provide conditional access to content based on the device identifier 401 (e.g., a token, a digital rights profile, a device serial number, etc.). The rights management module 403 can associate a watermarking rule 452 with each device identifier 401 to adaptively encode an identifiable watermark sequence 459 into a data stream of video content 420. Content can be transmitted via an encrypted and/or scrambled data stream (e.g., video content 420).

In an implementation, a content delivery network may transmit secure data streams (e.g., video content 420) that rely on the receiving user device (e.g., a set-top-box, smart television, conditional access module, etc.) authenticating prior to playback of the data stream. The content delivery network transmits keys encapsulated in a security message to enable the device to access the encrypted content. The device can include a personal rights management module (e.g., personal rights client 108 of FIG. 1) to remove (e.g., descramble and/or decode) a protection layer from a data stream (e.g., video content 420). A descrambler receives the key from a rights management module 403 of content delivery network to decrypt the data stream. A decoder transforms compressed format of the data stream into a format suitable for playback by the device.

In an implementation, rights management module 403 authenticates a device requesting a data stream based on a device identifier 401 and associates a watermarking rule 452 for subsequent requests from the device. The rights management module 403 determines a watermark payload 412 using the watermarking rule 452 associated with the device identifier 401. The rights management module 403 transmits a series of values as a watermark payload 412 to identify versions pre-watermarked with the embedded values that satisfy the watermarking rule 452. The rights management module 403 can use a secure channel 410 (e.g., a conditional access entitlement management message, or a direct point-to-point connection between the sender and the receiver) to deliver the watermark payload 412 to the adaptive watermarking service 425, as well as, keys for descrambling the video content 420.

In an implementation, the watermarking rule 452 may selectively include a watermark payload 412 and/or include a watermarking indicator 411 to disable and enable the adaptive watermarking service 425. For example, the watermark rule 452 can include a flag to activate the adaptive watermarking service 425 to select marked descrambled content with a watermark value 455 (e.g., 0 or 1). For example, the watermarking rule 452 may be an instruction to use a marked or unmarked version of the data stream. The watermark rule 452 can be a single bit (ON/OFF) and/or an indication of the embedded value in the selected version of the video content 420 that satisfies the watermarking rule 452 associated with the device.

In another implementation, set-top-box middleware 409 employs an embedded setup 408 that securely stores a device identifier on the device such that the identifier (e.g., a serial number embedded in a device) cannot be changed or otherwise read by a non-authorized party. The content delivery network can request the identifier from a device that is configured to send back the identifier. The adaptive watermarking service 425 can determine a watermarking rule associated with the request embedded identifier (or some identifying value derived from the embedded identifier) to determine watermark values 455 of versions of the video content 420 to transmit.

FIG. 5 is a flow diagram of one or more implementations of a method 500 for adaptive watermarking of digital content. Method 500 can be performed by processing logic that can comprise hardware (e.g., circuitry, dedicated logic, programmable logic, microcode, etc.), software (e.g., instructions run on a processing device), or a combination thereof. In an implementation, method 500 is performed by an adaptive watermarking service (e.g., adaptive watermarking service 151 of FIG. 1) executed by a processing device in an individualization server (e.g., individualization server 150 of FIG. 1). In an implementation, the individualization server is operatively coupled to a watermarking proxy (e.g., watermarking proxy 180 of FIG. 1) and a content delivery network (e.g., content delivery network 105 of FIG. 1). In some implementations, the content delivery network can perform parts of method 500 (e.g., blocks 501-503, and/or 521-523) via a pre-watermarking service (e.g., pre-watermarking service 114 of FIG. 1), the individualization server can perform parts of method 500 (e.g., blocks 505-513). At least a portion of method 500 can be performed automatically by the user device (e.g., without user interaction).

In some implementations, the block 501 and 503 are performed by the processing device of a head end server. At block 501, the processing device marks versions of content with a watermark value (e.g., 0 or 1). At block 503, the processing device publishes a manifest that includes addresses associated with versions of segments of content.

In an implementation, the processing device of the individualization server performs blocks 505-513. At block 505, the processing device receives a request that includes a device identifier and a retrieval address from the manifest associated with a first segment. In an implementation, the processing device of the individualization server receives the request via a proxy that receives requests from user devices and forwards the requests to the individualization server.

At block 507, the processing device identifies multiple versions of the first segment and storage locations of the versions in view of the requested address. In an implementation, as described in reference to FIG. 7, addresses in the manifest point to stored versions of a segment and the processing device identifies storage locations of multiple versions of the first segment encoded at different bitrates. In another implementation, as described in reference to FIG. 8, an address in the manifest may be associated with multiple stored copies of a segment. For example, duplicate copies of a segment encoded at the same bitrate may be stored with different watermark values. As described in reference to FIG. 8, the processing device of the individualization server can select one of the multiple to stored copies based on a cloaking address of a manifest.

At block 509, the processing device selects a return version with a watermark value that satisfies a watermarking rule. For example, the watermarking rule can compare the watermark value to a unique sequence of values associated with the device identifier. At block 511, the processing device sends a message including a return storage location that identifies the selected return version. The watermarking proxy receives the message and retrieves the return version from an origin server for delivery to the requesting device. At block 513, the processing device adds the watermark value to a watermark sequence associated with the device identifier and additional segment requests.

At 520, a detection method may be performed by a processing device of the individualization server or a digital rights management server with access to the watermark sequences of block 513. At block 521, the processing device identifies the watermark sequence in an unauthorized copy of the content. For example, automatic content recognition (ACR) can recognize content played on a media device or present in a media file. Devices containing ACR support enable devices to quickly obtain additional information (e.g., the watermark sequence) about the content played without any user based input. At block 523, the processing device determines the device identifier associated with the watermark sequence.

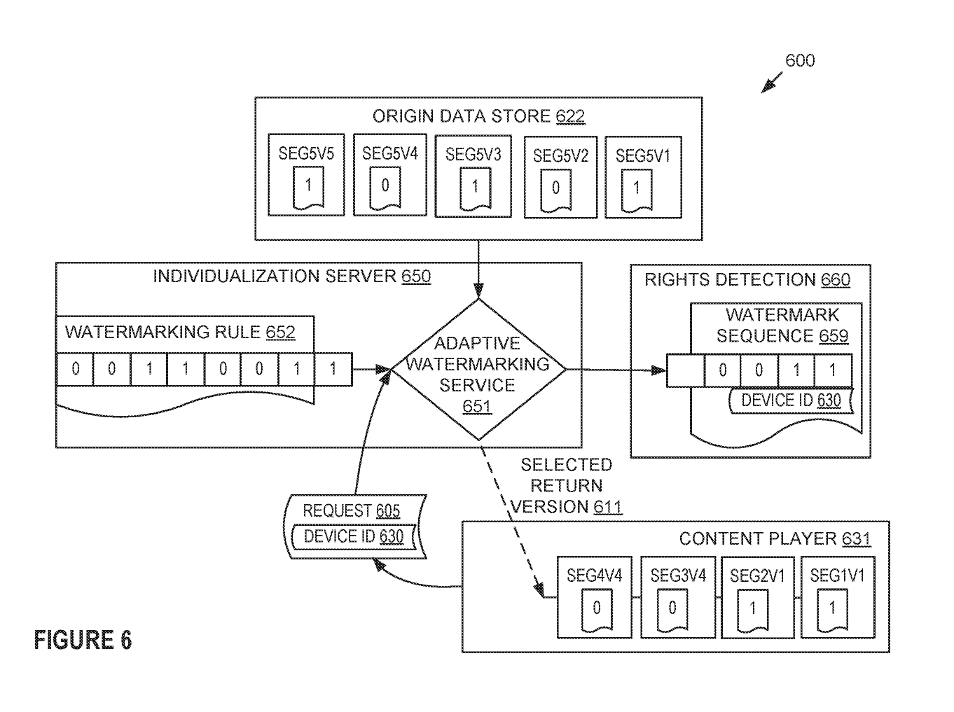

FIG. 6 illustrates a block diagram of an example adaptive watermarking process 600 in accordance with one or more implementations of the present disclosure. An individualization server 650 can be operatively coupled to an origin data store 622 via a watermarking proxy (e.g., watermarking proxy 180 of FIG. 1). The individualization server 650 can receive a request 605 for a segment of content that includes a device identifier (ID) 630 of the requesting user device. An adaptive watermarking service 651 of the individualization server 650 can select a return version 611 to be delivered based on a watermarking rule 652. The watermarking rule 652 may, for example, be a set of logic, library of strings, mathematical formula, cryptographic key, etc. that produces an identifiable sequence of values based on values embedded in versions of segments during a pre-watermarking phase (e.g., pre-watermarking service 114 of FIG. 1). The adaptive watermarking service 651 is compatible with different watermarking schemes such that the segments are embedded with values (e.g., 0 or 1) and a corresponding watermarking rule 652 is used to determine identifiable sequences of values.

In an implementation, an item of content is divided into segments (e.g., segments 1-5) and stored in an origin data store 622. Multiple versions of each segment can be created and marked with a watermark value (e.g., a 0 or a 1) during the pre-watermarking process. In an implementation, each version is encoded at a different quality level. Each version of a segment can correspond to a single quality level (e.g., bitrate).

For example, a first version is encoded at a very low quality with segments having a very low bitrate (e.g., 1 mbps), a second version is encoded at a low quality with segments having a low bitrate (e.g., 2 mbps), a third version is encoded at a middle of a range quality with segments having a mid-range bitrate (e.g., 3 mbps), a fourth version is encoded at a high quality with segments having a high bitrate (e.g., 4 mbps), and/or a fifth version is encoded at a very high quality with segments having a very high bitrate (e.g., 5 mbps). It is noted that the number of versions may depend on the number of supported bitrates by the content delivery network operator. In this example, the segments of the first version can be marked with a “1”, the segments of the second version may be marked with a “0”, the segments of the third version can be marked with a “1”, the segments of the fourth version can be marked with a “0”, and the segments of the fifth version can be marked with a “1,” as illustrated below in Table 1.

TABLE 1

| | | | Watermark |
|---|---|---|---|
| Version | Quality | Bitrate | Value |
| First version | Very low quality | 1 mbps | 1 |
| Second version | Low quality | 2 mbps | 0 |
| Third version | Middle quality | 3 mbps | 1 |
| Fourth version | High quality | 4 mbps | 0 |
| Fifth version | Very high quality | 5 mbps | 1 |

In this example, the origin data store 622 can store five versions (e.g., SEG5V1, SEG5V2, SEG5V3, SEG5V4, SEG5V4, SEG5V5, etc.) for each segment of the content item. The adaptive watermarking service 651 of the individualization server 650 can select a return version 611 (e.g., chunk) for each segment to produce a data stream (e.g., SEG1-SEG4) for playback by a content player 631 on a user device. The user device may request 605 a segment of the content item, as discussed in reference to FIG. 2. The request 605 can include a device ID 630 and a requested address for a segment. In an implementation, the request address may correspond to a version stored in the origin data store 622. In some implementations, the request 605 may include a bandwidth profile indicating a maximum requested bitrate the device can process (e.g., at a time of the content request).

In response to a user device sending a request 605, the adaptive watermarking service 651 can provide the requested series of segments from different versions based on a watermarking rule 652. In this example, the watermarking rule 652 indicates a series of values that the adaptive watermarking service 651 associates with the device ID. In response to sequential requests 605 for a next segment specifying a version, the adaptive watermarking service 651 can select a return version (herein the “selected return version 611”) of the next segment based on the watermarking rule 652. In an implementation, the adaptive watermarking service 651 provides the selected return version 611 that matches the bitrate of the requested version when the embedded value in the requested version satisfies the next value in the series from the watermarking rule 652. In response to the requested version not satisfying the next value in the series from the watermarking rule 652, the adaptive watermarking service 651 can select a different version of the segment as the selected return version 611 in view of the requested bitrate of the requested version.

For example, the adaptive watermarking service 651, using the device ID 630, can use the watermarking rule 652 to identify a series of values (e.g., 110011001100). A request 605 for a first segment may indicate the user device is configured to receive data at or near the very low quality (e.g., bitrate), which may correspond to the first version of the first segment. The adaptive watermarking service 651 determines if the embedded value of the first version of the first segment satisfies a first value in the series from the watermarking rule 652. Since the value of the first version matches the first value in the series, adaptive watermarking service 651 returns the first version as the selected return version 611. The device receives the first version of the first segment that is marked with a 1.

In some cases, the adaptive watermarking service 651 may select a different version of a segment than the requested version in order to satisfy the watermarking rule 652. In an implementation, the adaptive watermarking service 651 may select a version with a different quality level than the requested version of the segment. For example, the selected return version 611 can be the version at the closest quality level to the requested quality level that includes the mark that satisfies the watermarking rule 652. Accordingly, the adaptive watermarking service 651 selects the selected return version 611 based on the bitrate associated with a request 605 and based on the watermark value in the series as determined in view of the watermarking rule 652. For example, a request 605 for a second segment specifying a version at the low quality corresponds to a version marked with a “0” in Table 1. The adaptive watermarking service 651 determines the second value in the series from the watermarking rule 652 is a “1”. Accordingly, the mark of the requested version does not satisfy the watermarking rule 652. The adaptive watermarking service 651 may select the first version of the second segment at a very low quality level in order to satisfy the watermarking rule 652 since the first version is marked with a “1”.

For the third segment, if the device requests the fifth version corresponding to a very high quality, the adaptive watermarking service 651 identifies the fifth version of the third segment is marked with a “1” in the origin data store 622. The adaptive watermarking service 651 determines the watermark value of the requested version (i.e., “1”) does not satisfy the third watermark value in the series (i.e., “0”) from the watermarking rule 652. The adaptive watermarking service 651 identifies a next lower quality version (e.g., version four encoded at a high quality in Table 1) and determines the watermark value of the next lower quality version (i.e., “0”) does satisfy the third value in the series (i.e., “0”) from the watermarking rule 652. Accordingly, the fourth version of the third segment is selected as the return version 611.

The watermarking rule 652 may include additional logic or steps to identify a watermark value that satisfies the watermarking rule 652. As each selected return version 611 is identified and provided to the user device, the adaptive watermarking service 651 adds the watermark value to the selected return version to a watermarking sequence 659 associated with the device ID 630 for rights detection 660, as discussed in reference to FIG. 5. In some implementations, the watermarking sequence 659 may include additional data, such as the bitrate of the return version, a timestamp, metadata from request 605, etc. Therefore, the watermarking is implemented by providing versions of segments with the appropriate suite of “0” and “1” with varying the bitrate to produce an identifiable watermarking sequence 359.

FIG. 7 is a flow diagram of one implementation of a method 700 for adaptive watermarking of versions of digital content. Method 700 can be performed by processing logic that can comprise hardware (e.g., circuitry, dedicated logic, programmable logic, microcode, etc.), software (e.g., instructions executed by a processing device), or a combination thereof. In an implementation, method 700 is performed by an adaptive watermarking service (e.g., adaptive watermarking service 151 of FIG. 1) executed by a processing device in an individualization server (e.g., individualization server 150 of FIG. 1). In an implementation, the individualization server is operatively coupled to a watermarking proxy (e.g., watermarking proxy 180 of FIG. 1) and a content delivery network (e.g., content delivery network 105 of FIG. 1). In an implementation, at least a portion of method 700 may be performed by the user device, such as, for example, without user interaction with regard to particular portions of the method.

At block 705, the processing device (e.g., of an individualization server) receives a manifest (e.g., published by a content delivery network or individualization sever) that includes addresses corresponding to versions of a segment. The common manifest can be published by a content delivery network with a URL, for example, as a retrieval address pointing to a version of a segment. In an implementation, the multiple versions of a segment of content are encoded at different bitrates and each version is marked with a watermark value based on the bitrate. For example, each segment may have a first version encoded at a low bitrate marked with a first value and a second version encoded at a high bitrate marked with a second value, as described above in detail. At block 707, the processing device receives a request from a user device including a user device identifier, an address of a version of a segment, and available bandwidth information. At block 709, the processing device identifies a version based on the requested address. At block 711, the processing device, determines if the watermark value of the identified version satisfies a watermarking rule.

In response to the watermark value of the identified version failing to satisfy the watermarking rule, the processing device at block 713, identifies another version encoded at another quality level (e.g., a version encoded at a next lower bitrate). In response to the watermark value of the identified version satisfying the watermarking rule, the processing device the processing device, at block 715, selects a return address for the identified version. In an example, the return address is the requested address if the requested version is marked with a watermark value that matches the watermarking rule. At block 717, the processing device sends a message including the return address for the identified version. At block 719, the processing device adds the watermark value to a watermark sequence associated with the device identifier and additional segment requests.

FIG. 8 is a flow diagram of one implementation of a method 800 to adaptively watermark copies of digital content. Method 800 can be performed by processing logic that can comprise hardware (e.g., circuitry, dedicated logic, programmable logic, microcode, etc.), software (e.g., instructions run on a processing device), or a combination thereof. In an implementation, method 800 is performed by an adaptive watermarking service (e.g., adaptive watermarking service 151 of FIG. 1) executed by a processing device in an individualization server (e.g., individualization server 150 of FIG. 1). In an implementation, the individualization server is operatively coupled to a watermarking proxy (e.g., watermarking proxy 180 of FIG. 1). At least a portion of method 800 can be performed automatically by the user device without user interaction.

Some implementations of a content delivery networks store duplicate copies of segments encoded at the same bitrate and mark each copy with a watermark value (e.g., 0 or 1). The content delivery networks employ a unique manifest for each requesting device that contains addresses for a unique combination of the duplicate copies of segments. Content delivery networks that use unique manifests generally require additional storage resources and complicated downstream processing to respond to requests. In an example, the duplicate copies of segments can be encoded at the same bitrate and embedded with a different watermark value. Since duplicate copies are stored for each segment of each piece of available content, the content delivery network storage demands multiply. Several unique manifests are published to identify the respective devices. The several unique manifests also expose the content storage devices to collusion attacks, for example, by attackers that combine multiple unique manifests to identify address of duplicate copies to circumvent detection. Implementations of the method 800 describe an adaptive watermarking service that can thwart attacks and reduce vulnerabilities of content delivery networks that use unique manifests to stream data.

At block 801, the processing device receives storage locations for multiple copies of a segment of content encoded at the same bitrate, where each copy is marked with a different watermark value. At block 803, the processing device generates a cloaking address that corresponds to the storage locations of the copies of the segment encoded at the same bitrate. At block 805, the processing device maintains an index of cloaking addresses and storage locations for copies of each segment of content encoded at each bitrate. At block 807, the processing device publishes a common manifest that includes cloaking addresses, from the index, for each segment at each respective bitrate of the multiple bitrates.

At block 809, the processing device receives a request from a user device including a device identifier, and a requested cloaking address from the common manifest. For example, the processing device can use the cloaking address to look-up, in the index, the storage location of the copies of the segment encoded at the same bitrate of the request.

At block 811, the processing device identifies, in the index, multiple storage locations of copies of a first segment encoded at the same bitrate corresponding to the requested cloaking address. At block 813, the processing device selects the copy with a watermark value that satisfies a watermarking rule. In response to a watermark value of “0” satisfying the watermarking rule, the processing device, at block 815, sends a message including a return storage location, from the index, of the copy marked with a watermark value of “0”. In response to a watermark value of “1” satisfying the watermarking rule, the processing device, at block 817, sends a message including a return storage location, from the index, of the copy marked with a watermark value of “1”. At block 819, the processing device adds the watermark value to a watermark sequence associated with the device identifier and additional segment requests.

In implementations employing unique manifests, a proxy server (e.g., the watermarking proxy 180 of FIG. 1) and an individualization server can provide the adaptive watermarking service that generates a common manifest of cloaking addresses for duplicate copies of a segment encoded at a single quality level. The pre-watermarking service marks the copies with different watermark values. The copies are stored in an origin server. The adaptive watermarking service on the individualization server builds an index to associate a cloaking address with multiple storage locations for the multiple copies. The adaptive watermarking service publishes a common manifest of cloaking addresses that devices can use for generating requests. The common manifest published by the individualization server to several devices can replace unique manifests published by the content delivery network to each device.

A device sends a retrieval address that is cloaking address from the common manifest corresponding to the segment encoded at a bitrate. The proxy can intercept requests from devices and forward the requests to the individualization server. The adaptive watermarking service can respond to the device request by looking up the cloaking address in the index to identify the multiple storage locations associated with a copy of the segment. The adaptive watermarking service selects the copy with the watermark value that satisfies a watermarking rule. Then adaptive watermarking service messages the proxy with the storage location of the return version and the proxy delivers the selected version to the device. Then adaptive watermarking service creates an identifiable watermark sequence using the duplicate copies of segment encoded at the same bitrate with different watermark values. The watermark sequence is associated with the request device and the common manifest thwarts collusion attacks.

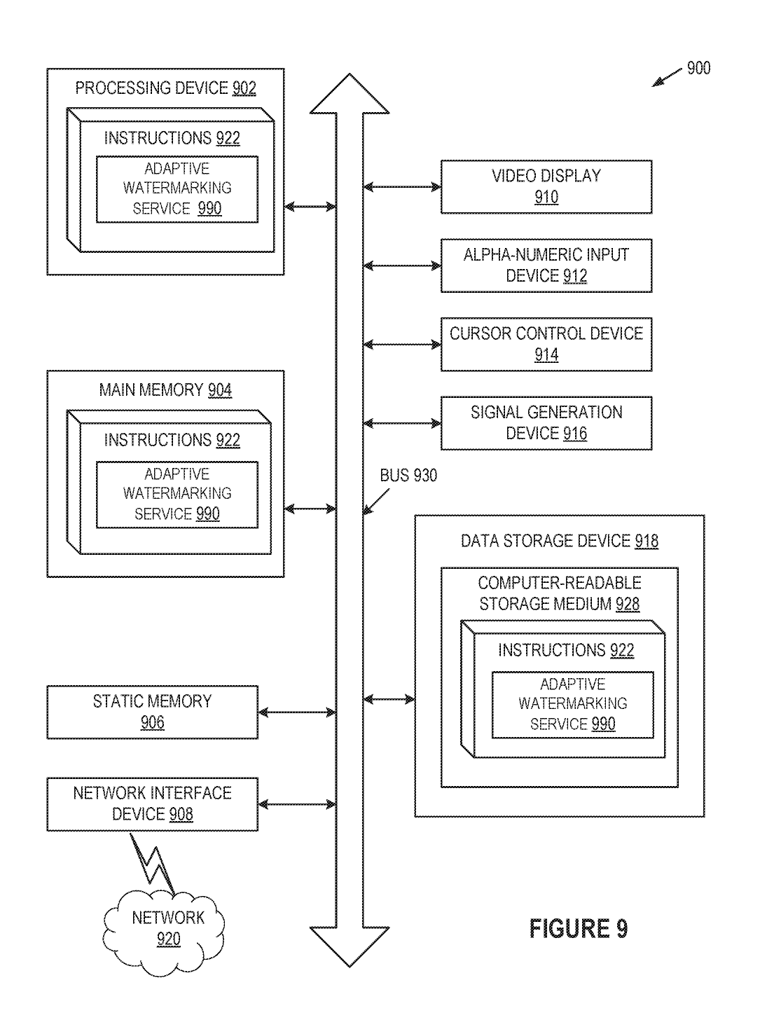

FIG. 9 illustrates a block diagram of one implementation of a computing device 900 within which a set of instructions, for causing the machine to perform any one or more of the methodologies discussed herein, may be executed. In alternative implementations, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 900 includes a processing device 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a secondary memory (e.g., a data storage device 918), which communicate with each other via a bus 930.

Processing device 902 represents one or more general-purpose processors such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. Processing device 902 is configured to execute the processing logic (instructions 922) for performing the operations and steps discussed herein.

The computing device 900 may further include a network interface device 908. The computing device 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 916 (e.g., a speaker).

The data storage device 918 may include a machine-readable storage medium (or more specifically a non-transitory computer-readable storage medium) 928 on which is stored one or more sets of instructions 922 embodying any one or more of the methodologies or functions described herein. The instructions 922 may also reside, completely or at least partially, within the main memory 904 and/or within the processing device 902 during execution thereof by the computer system 900, the main memory 904 and the processing device 902 also constituting computer-readable storage media.

The computer-readable storage medium 928 may also be used to store an adaptive watermarking service engine 990 (as described with reference to FIGS. 4-8), and/or a software library containing methods that call an adaptive watermarking service engine 990. While the computer-readable storage medium 928 is shown in an example implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium other than a carrier wave that is capable of storing or encoding a set of instructions for execution by the machine and that cause the machine to perform any one or more of the methodologies described herein. The term “computer-readable storage medium” shall accordingly be taken to include, but not be limited to, solid-state memories, and optical and magnetic media.

In an implementation, the modules, components and other features described herein (for example adaptive watermarking service engine in relation to FIGS. 4-8) can be implemented as discrete hardware components or integrated in the functionality of hardware components such as ASICS, FPGAs, DSPs or similar devices as part of an individualization server (e.g., individualization server 150 of FIG. 1). In addition, the modules can be implemented as firmware or functional circuitry within hardware devices. Further, the modules can be implemented in any combination of hardware devices and software components, or only in software.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving”, “generating”, “publishing”, “transmitting”, “selecting”, “sending”, “storing”, “determining”, “maintaining,” “identifying,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Implementations of the present disclosure also relate to an apparatus for performing the operations herein. This apparatus may be specially constructed for the discussed purposes, or it may comprise a general purpose computer system selectively programmed by a computer program stored in the computer system. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A method comprising:
receiving a request comprising a device identifier and a requested address associated with a first segment of content, wherein the requested address is identified in a published manifest describing a plurality of segments for a content item, wherein each segment of the plurality of segments is encoded at a plurality of bitrates;
identifying, by a processing device, a plurality of storage locations of the first segment in view of the requested address, the plurality of storage locations each comprising a version of the first segment having a watermark value;
selecting, by the processing device, a return version from the versions associated with the first segment in view of a watermarking rule, the return version comprising a watermark value satisfying the watermarking rule; and
sending a message comprising the device identifier and a return storage location that identifies the selected return version.

2. The method of claim 1, wherein the published manifest comprises storage locations for each version of each segment encoded at a different bitrate of the plurality of bitrates, and the requested address is the storage location for the first segment encoded at a requested bitrate.

3. The method of claim 2, wherein identifying the plurality of storage locations of the first segment further comprises:
identifying multiple storage locations from the published manifest corresponding to the first segment encoded at each bitrate of the plurality of bitrates;
wherein selecting the return version further comprises:
determining the watermark values for the identified versions encoded at a bitrate less than or equal to the requested bitrate;
selecting the return version based on a watermark value of the identified versions satisfying the watermarking rule; and
determining the return storage location that identifies the selected return version from the published manifest.

4. The method of claim 1, further comprising:
maintaining an index of storage locations and cloaking addresses identified in the published manifest, wherein each cloaking address corresponds to each segment encoded at each bitrate, the index comprising a cloaking address for each segment of content encoded at each bitrate of the multiple bitrates, wherein a cloaking address of the first segment encoded at a bitrate corresponds to two or more versions, the two or more versions comprising copies of the first segment encoded at the same bitrate, each copy having a different watermark value; and
wherein the published manifest comprises cloaking addresses for each segment encoded at each bitrate, and the requested address is a requested cloaking address for the first segment encoded at a requested bitrate.

5. The method of claim 4, wherein identifying the multiple storage locations further comprises:
identifying, in the index, two or more storage locations corresponding to first segment encoded at the requested bitrate in view of the requested cloaking address;
wherein selecting the return version of the associated versions further comprises:
determining the watermark values for the two or more identified storage locations; and
selecting the return storage location based on the watermark values for the identified versions in the two or more identified storage locations, wherein the return version comprises the watermark value satisfying the watermarking rule is in view of the device identifier.

6. The method of claim 1, wherein the multiple versions of the first segment are encoded at different bitrates with alternating watermarking values.

7. The method of claim 1, wherein the multiple versions of a segment are duplicate copies of the first segment encoded at the same bitrate with different watermarking values.

8. The method of claim 1, further comprising:
adding the watermark value of the selected return version to a watermark sequence associated with the device identifier and additional segment requests from the device, wherein the watermark sequence is identifiable in an unauthorized copy of the content, and traceable to the device identifier associated with the watermark sequence.

9. The method of claim 1, wherein the message causes a requesting device to receive the return version embedded with the watermark value satisfying the watermark rule.

10. A method comprising:
receiving, by a processing device, a manifest describing a plurality of segments for a content item, the manifest comprising retrieval addresses identifying multiple versions of each segment of the plurality of segments, each version encoded at a different bitrate and comprises a watermark value based on the encoded bitrate;
receiving a request comprising a device identifier and a first requested version for a first segment;
selecting, by the processing device, a return version associated with the first segment in view of a watermarking rule, wherein the return version is encoded at a bitrate less than or equal to the bitrate of the requested version; and
sending a message comprising a retrieval address that identifies the selected return version associated with the first segment.

11. The method of claim 10, wherein the watermarking rule matches the watermark of the selected return version to a watermarking sequence associated with the device identifier.

12. The method of claim 10, wherein the bitrate of the requested version is determined in view of a bitrate associated in the manifest with the requested version.

13. The method of claim 10, further comprising adding the watermark value of the selected return version to a watermark sequence associated with the device identifier and additional segment requests from the device.

14. The method of claim 10, wherein the content is audio or video content; and wherein the versions are for adaptive bitrate streaming.

15. A system comprising:
a memory to store instructions; and
a processing device operatively coupled to the memory, the processing device to execute the instructions to:
receive storage locations for plurality copies of a segment of content encoded at the same bitrate, wherein each copy is marked with a different watermark value;
generate a cloaking address that corresponds to the storage locations of the copies of the segment encoded at the same bitrate;
maintain an index of storage locations and cloaking addresses, the index comprising a cloaking address for each segment of content encoded at each bitrate of the plurality bitrates;
publish a common manifest comprising cloaking addresses for each segment at plurality bitrates;
receiving a request comprising a device identifier and a first requested cloaking address for a first segment encoded at a requested bitrate;
identify, in the index, plurality storage locations of copies of the first segment encoded at the requested bitrate;
select a return copy associated with the identified storage locations in view of a watermarking rule, the return copy comprising a watermark value that satisfies the watermarking rule; and
send a message comprising a retrieval address that identifies the selected return copy associated with the first segment.

16. The system of claim 15, wherein cloaking address is a uniform resource locators, the common manifest is published to a plurality of devices, and the index that comprises storage locations is not directly accessible by the plurality of devices.

17. The system of claim 15, wherein the processing device is further to:
receive an additional request, the additional request to include the device identifier and an additional cloaking address associated with a second segment of the plurality of segments; and
select a second return copy associated with the second segment in view of the watermarking rule, the second return copy comprising a watermark value satisfying the watermarking rule.

18. The system of claim 15, wherein the watermarking rule matches the watermark of the selected return copy to a watermarking sequence associated with the device identifier.

19. The system of claim 15, wherein the processing device is further to authenticate the request based on the device identifier or a received token.

20. The system of claim 15, wherein the processing device is further to add the watermark value of the selected return copy to a watermark sequence associated with the device identifier and additional segment requests from the device.
